(19) United States
(12) Patent Application Publication
(10) Pub. No.: US 2026/0031382 A1
(43) Pub. Date: Jan. 29, 2026

(54) APPARATUS FOR FORMING FOLDING GUIDE LINE, MANUFACTURING METHOD OF BATTERY CELL, AND BATTERY CELL

(71) Applicant: SK ON CO., LTD., Seoul (KR)

(72) Inventors: Seung Hyeon CHEON, Daejeon (KR); Sung Yeop KIM, Daejeon (KR); Jun Hyung BYUN, Daejeon (KR); Seong Yun LEE, Daejeon (KR)

(21) Appl. No.: 19/254,007

(22) Filed: Jun. 30, 2025

(30) Foreign Application Priority Data
Jul. 29, 2024 (KR) 10-2024-0100434

(51) Int. Cl. H01M 10/04; H01M 50/105

(52) U.S. Cl. CPC H01M 10/0404; H01M 50/105

(57) ABSTRACT

The present disclosure provides an apparatus for forming a folding guide line including: a forming tool forming a folding guide line in a terrace disposed in at least a portion of a periphery of an electrode accommodation portion of a battery cell; and a heating press heating an inner region of the terrace, and the inner region of the terrace heated by the heating press is disposed between the folding guide line and the electrode accommodation portion.

### CROSS-REFERENCE TO RELATED APPLICATION(S)

This patent document claims the priority and benefits of Korean Patent Application No. 10-2024-0100434 filed on Jul. 29, 2024, the disclosure of which is incorporated herein by reference in its entirety.

### TECHNICAL FIELD

The disclosure and implementations disclosed in this patent document generally relate to an apparatus for forming a folding guide line, a manufacturing method of a battery cell, and a battery cell.

### BACKGROUND

Unlike primary batteries, secondary batteries (battery cells) are receiving significant attention as power sources for various mobile devices, electric vehicles, and energy storage devices, as secondary batteries have convenience in being able to be charged with and discharged of electricity.

Secondary batteries may be manufactured as pouch-type battery cells or can-type battery cells. A pouch-type battery cell has a structure in which an electrode assembly is accommodated inside a flexible pouch case. A can-type battery cell has a structure in which an electrode assembly is accommodated inside a rigid case and may be comprised of a cylindrical battery cell or a square battery cell.

The pouch case of a pouch-type battery cell includes an electrode accommodation portion accommodating an electrode assembly and a terrace disposed on at least a portion of a periphery of the electrode accommodation portion and having a shape extending outwardly from the electrode accommodation portion. In some regions of the terrace, an inner layer of a pouch case is subject to heat-melting (compressing) to form a sealing portion. The sealing portion seals an electrode accommodating portion from the outside.

### SUMMARY

In a pouch-type battery cell, a sealing portion needs to have a width of a certain size or more to block an electrode accommodation portion from the outside. When the width of the sealing portion increases, an overall volume of a battery cell may increase, which may adversely affect the energy density of the battery cell. Accordingly, a process of folding a terrace on which electrode leads are not disposed may be performed in a general battery cell manufacturing process.

In order to easily fold the terrace, a process of forming a folding guide line in the terrace may be performed before the folding process. The folding guide line may have a groove shape extending along a length of the terrace. The folding process may fold the terrace along the folding guide line.

Meanwhile, in the battery cell manufacturing process, processes such as pressing, formation, and high-temperature aging are performed before the folding process. During these processes, an insulation of the battery cell may be destroyed or an insulation level may be lowered. When the folding process is performed on a battery cell with a low insulation level, the insulation level may be further deteriorated, which may lead to the problem in which the battery cell should be discarded.

According to an aspect of the present disclosure, an apparatus for forming f a folding guide line capable of improving insulation performance in a forming process of the folding guide line, a manufacturing method of a battery cell, and a battery cell may be provided.

According to an aspect of the present disclosure, an apparatus for forming a folding guide line capable of restoring insulation performance of a battery cell or improving the insulation performance of the battery cell as compared to a previous process, a manufacturing method of a battery cell, and a battery cell may be provided.

According to an aspect of the present disclosure, an apparatus for forming a folding guide line capable of improving the quality and durability of a folding portion, a manufacturing method of a battery cell, and a battery cell may be provided.

According to an aspect of the present disclosure, an apparatus for forming a folding guide line capable of reducing insulation defects of a battery cell, a manufacturing method of a battery cell, and a battery cell may be provided.

A battery cell manufactured by the apparatus for forming a folding guide line and the manufacturing method of a battery cell of the present disclosure may be widely applied to electric vehicles, battery charging stations and devices within green technology fields such as solar and wind power generation using other batteries. In addition, the battery cell manufactured by the apparatus for forming a folding guide line and the manufacturing method of a battery cell of the present disclosure may be used in eco-friendly electric vehicles, hybrid vehicles, or the like, to ameliorate the effects of climate change by suppressing air pollution and greenhouse gas emissions.

An apparatus for forming a folding guide line according to the present disclosure may include: a forming tool forming a folding guide line in a terrace disposed in at least a portion of a periphery of an electrode accommodation portion of a battery cell; and a heating press heating an inner region of the terrace, wherein the inner region of the terrace heated by the heating press may be disposed between the folding guide line and the electrode accommodation portion.

In an embodiment, the heating press may be disposed between the forming tool and the electrode accommodation portion in a first direction in which the terrace extends from the electrode accommodation portion.

In an embodiment a pressurizing surface of the forming tool and a heating surface of the heating press may be spaced apart from each other in the first direction.

In an embodiment, the terrace may include a sealing portion, which is a sealed region, an unsealing portion, which is an unsealed region, the forming tool may form the folding guide line in the sealed region, and the heating press may heat a region including at least a portion of the unsealing portion.

In an embodiment, the inner region of the terrace may include a boundary between the sealing portion and the unsealing portion, and the heating press may simultaneously heat a portion of the sealing portion and a portion of the unsealing portion.

In an embodiment, the inner region of the terrace may be spaced apart from the sealing portion, and the heating press may heat the unsealing portion.

In an embodiment, the inner region of the terrace may include a region in which an inner folding line provided to fold the terrace in a different position from the folding guide line is disposed.

In an embodiment, the forming tool and the heating press may be independently driven.

In an embodiment, the forming tool and the heating press may have different values for at least one of a heating temperature, pressurizing force, pressurizing time or a pressurizing height.

The apparatus for forming a folding guide line in an embodiment may further include: a first driver driving the forming tool to pressurize the terrace; and a second driver driving the heating press to pressurize the heating press.

In an embodiment, a second set temperature of the heating press may have a higher value than a first set temperature of the forming tool.

In an embodiment, the second set temperature may be equal to or higher than a melting temperature of a resin layer provided in the terrace.

The apparatus for forming a folding guide line in an embodiment may further include: a heating portion heating at least one of the forming tool and the heating press.

In an embodiment, the heating portion may include a first heater heating the forming tool, and a second heater heating the heating press, and a set temperature of the first heater and a set temperature of the second heater may have different values.

In an embodiment, the forming tool and the heating press may be driven together by a single driver.

In an embodiment, the forming tool includes a first pressurizing tool and a second pressurizing tool disposed with the terrace interposed therebetween, and the first pressurizing tool may include a flat first pressurizing surface and an accommodation groove having a recessed form in the first pressurizing surface, and the second pressurizing tool may include a flat second pressurizing surface and a pressurizing protrusion disposed in a position corresponding to the accommodation groove and having a shape in which at least a portion thereof protrudes from the second pressurizing surface.

In an embodiment, the heating press may include a first press and a second press disposed with the terrace interposed therebetween, and the first press may include a flat first heating surface, and the second press may include a flat second heating surface, and in a first direction in which the terrace extends from the electrode accommodation portion, the first heating surface may be spaced apart from the first pressurizing surface, and the second heating surface may be spaced apart from the second pressurizing surface.

An apparatus for forming a folding guide line according to another aspect of the present disclosure comprises: a forming tool forming a folding guide line in a terrace disposed in at least a portion of a periphery of an electrode accommodation portion of a battery cell; and a heating press heating the terrace, and the heating press is disposed between the forming tool and the electrode accommodation portion and may operate independently of the forming tool.

A manufacturing method of a battery cell according to the present disclosure may include: a sealing process of forming a sealing portion by sealing a terrace disposed in at least a portion of a periphery of an electrode accommodation portion of a battery cell; and a folding guide line forming process of forming a folding guide line in the sealing portion of the terrace, and the folding guide line forming process may heat an inner region of the terrace while forming a folding guide line in the terrace, and the inner region of the terrace may be disposed between the folding guide line and the electrode accommodation portion, and a pressurizing surface on which the folding guide line is formed and a heating surface provided to the inner region of the terrace may be spaced apart from each other.

In an embodiment, the terrace may include the sealing portion, which is a region sealed by the sealing process, and an unsealing portion, which is a region unsealed by the sealing process, and the inner region of the terrace heated by the folding guide line forming process may include at least a portion of the unsealing portion.

In an embodiment, the heating surface provided as the inner region of the terrace may include a boundary between the sealing portion and the unsealing portion, or may be spaced apart from the sealing portion.

The manufacturing method of a battery cell may further include: a folding process of folding the terrace after the folding guide line forming process, and the folding process may include a process of folding the terrace based on the folding guide line.

A battery cell according to the present disclosure may include: an electrode assembly; and a pouch case including an electrode accommodation portion forming an accommodation space for accommodating the electrode assembly, and a terrace disposed in at least a portion of a periphery of the electrode accommodation portion and extending outwardly from the electrode accommodation portion, and the terrace may include a folding guide line formed by an apparatus for forming a folding guide line described above.

In an embodiment, the terrace may have a folded shape based on the folding guide line.

According to an embodiment of the present disclosure, insulation performance may be improved in a folding guide line forming process.

According to an embodiment of the present disclosure, insulation performance of a battery cell may be restored or insulation performance of a battery cell may be improved as compared to a previous process.

According to an embodiment of the present disclosure, the quality and durability of a folding portion may be improved.

According to an embodiment of the present disclosure, an insulation defect of a battery cell may be reduced.

### BRIEF DESCRIPTION OF DRAWINGS

Certain aspects, features, and advantages of the present disclosure are illustrated by the following detailed description with reference to the accompanying drawings.

FIG. 1 is a schematic diagram illustrating an example of a battery cell before a folding guide line is formed.

FIGS. 2A to 2F sequentially illustrate a process of forming a folding portion in a sealing portion of a battery cell.

FIG. 3A is an enlarged schematic diagram illustrating part “A” of FIG. 1, and FIG. 3B is a cross-sectional view illustrating a state in which a folding guide line is formed along line I-I′ of FIG. 3A.

FIG. 4 is a perspective view illustrating a battery cell according to an embodiment.

FIG. 5 is a schematic diagram illustrating an apparatus for forming a folding guide line according to an embodiment.

FIG. 6A and FIG. 6B illustrate an apparatus for forming a folding guide line according to an embodiment, where FIG. 6A illustrates a state in which a terrace is pressurized, and FIG. 6B illustrates a state in which a folding guide line is formed by pressurizing a terrace.

FIG. 6C illustrates a state in which a terrace is first folded based on the folding guide line formed in FIG. 6B.

FIG. 7 is a schematic diagram illustrating an apparatus for forming a folding guide line according to another embodiment.

FIGS. 8A and 8B illustrate an apparatus for forming a folding guide line according to another embodiment. FIG. 8A illustrates a state in which a terrace is pressurized, and FIG. 8B illustrates a state in which a folding guide line is formed by pressurizing a terrace.

FIG. 8C illustrates a state in which a terrace is first folded based on the folding guide line formed in FIG. 8B.

FIGS. 9 to 11 are schematic diagrams illustrating an apparatus for forming a folding guide line according to another embodiment.

FIG. 12 is a flow chart illustrating a manufacturing method of a battery cell according to an embodiment.

### DETAILED DESCRIPTION

Hereinafter, the present disclosure will be described in detail with reference to the attached drawings. However, this is merely exemplary and the present disclosure is not limited to the specific embodiments described as exemplary.

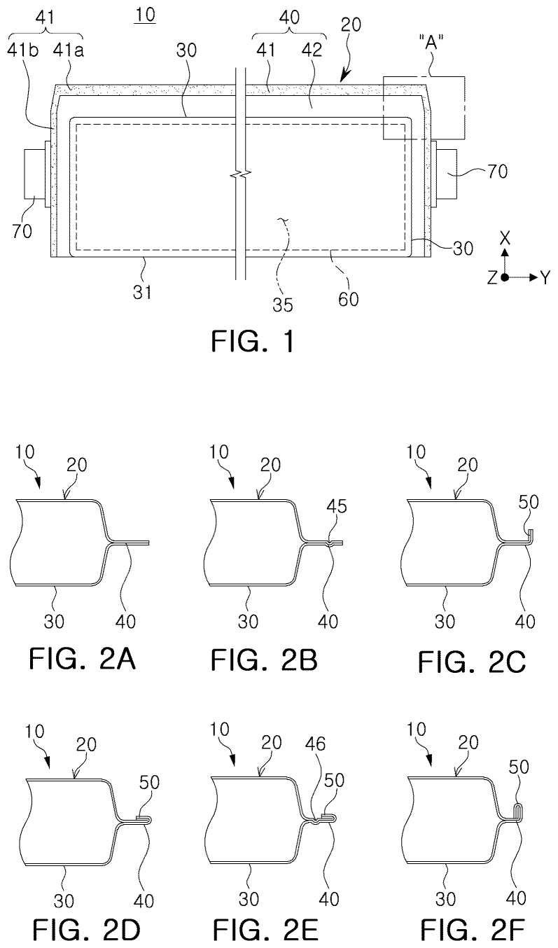

FIG. 1 is a schematic diagram illustrating an example of a battery cell 10 before a folding guide line 45 is formed.

Referring to FIG. 1, the battery cell 10 may include a pouch case 20 and an electrode assembly 60 accommodated inside the pouch case 20. An electrode lead 70 connected to the electrode assembly 60 may be exposed to the outside of the pouch case 20. The electrode assembly 60 may include a cathode plate, an anode plate, and a separator. The separator may be disposed between the cathode plate and the anode plate.

The pouch case 20 may include an electrode accommodation portion 30 forming an accommodation space 35 for accommodating the electrode assembly 60, and a terrace 40 disposed in on at least a portion of a periphery of the electrode accommodation portion 30 and extending outwardly from the electrode accommodation portion 30.

The terrace 40 may be sealed by heat-melting an edge or a portion adjacent to the edge. The terrace 40 may include a sealing portion 41, which is a sealed region in the terrace, and an unsealing portion 42, which is an unsealed region in the terrace. The sealing portion 41 may form a sealed region, and the unsealing portion 42 may form an unsealed region. The unsealing portion 42 may be formed between the sealing portion 41 and the electrode accommodation portion 30. The sealing portion 41 may protect the electrode assembly 60 from the outside by heat-melting surfaces of the pouch case 20 that are in contact with each other.

The sealing portion 41 may include a first sealing portion 41a in which the electrode lead 70 is not disposed and a second sealing portion 41b in which the electrode lead 70 is disposed. When forming the electrode accommodation portion 30 by folding a single pouch case 20, three surfaces, among four surfaces of the electrode accommodation portion 30, may be open and one surface 31 may be closed. A sealing portion 41 may be formed on the three open surfaces of the electrode accommodation portion 30.

The battery cell 10 according to an embodiment is not limited to a structure in which the sealing portion 41 is formed on the three surfaces of the electrode accommodation portion 30. For example, the battery cell 10 may also have a configuration in which the electrode accommodation portion 30 is formed by overlapping two pouch cases 20. In this case, the sealing portion 41 may be formed on all four surfaces of the electrode accommodation portion 30.

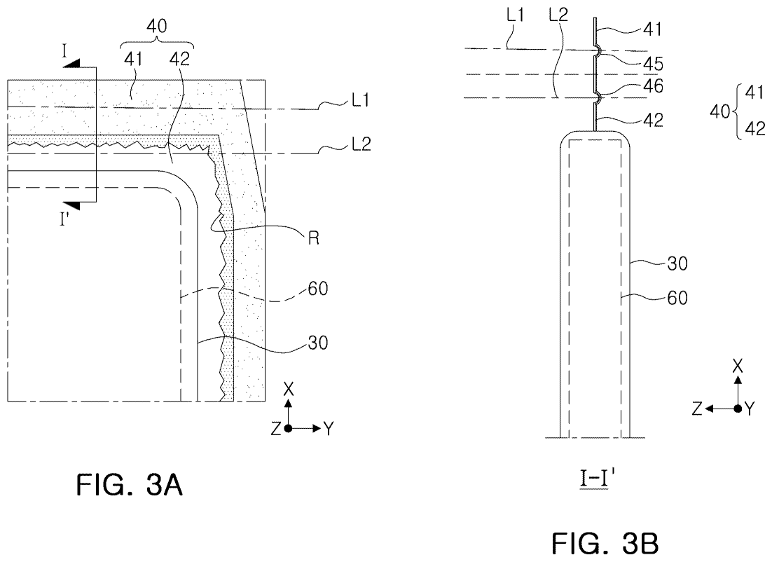

FIGS. 2A to 2F sequentially illustrate a process of forming a folding portion 50 in a terrace 40 of a battery cell 10. FIGS. 2A to 2F illustrate a state in which the electrode assembly 60 is omitted.

Referring to FIGS. 2A to 2F together with FIG. 1, the battery cell 10 may include a sealing portion 41 formed on the terrace 40 through a sealing process. The terrace 40 may be folded to increase the joint reliability of the sealed sealing portion 41 and reduce the volume occupied by the terrace 40.

FIG. 2A illustrates a state in which a sealing portion 41 is formed in the terrace 40 through a sealing process. The terrace 40 of the battery cell 10 may have an angle of 0 degrees before a folding guide line forming process and a folding process are performed.

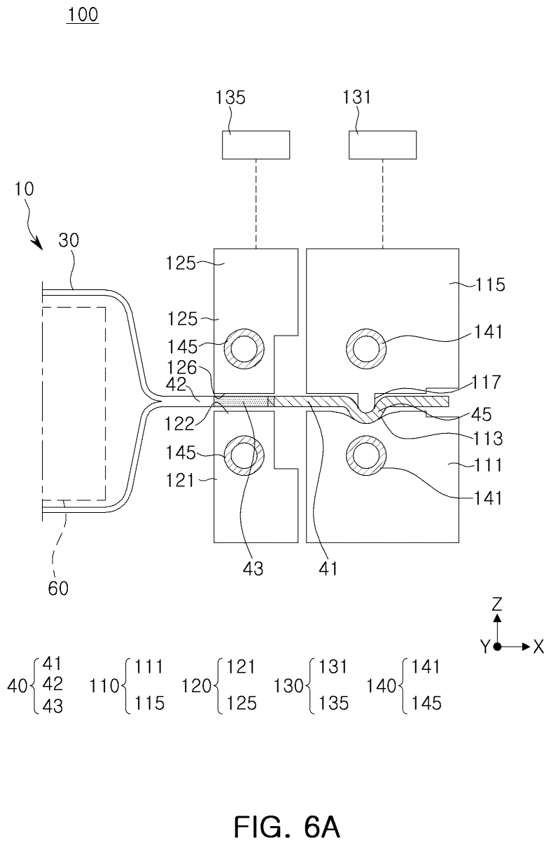

FIG. 2B illustrates a state in which a folding guide line 45 is formed in the terrace 40 of the battery cell 10. The folding guide line 45 may be formed as a line spaced apart from the electrode accommodation portion 30 by a certain distance and formed along a length direction of the terrace 40. The folding guide line 45 may have a groove shape. As an example, the folding guide line 45 may be formed by an apparatus (for example, 100 of FIG. 5) for forming a folding guide line described below.

FIGS. 2C to 2F illustrate an example of a folding process. The folding process may fold the first sealing portion 41a in which the electrode lead 70 is not disposed, among the sealing portions 41 of the terrace 40. In an embodiment, the terrace 40 may form a folding portion 50 folded at a specific angle after undergoing at least one folding process.

FIG. 2C illustrates a folding portion 50 in which the terrace 40 is folded based on a folding guide line 45 through a first-first folding process. The first-first folding process is a process in which the terrace 40 is folded at a specific angle (for example, approximately 90 degrees). Since the folding guide line 45 having a groove shape is formed in advance in the terrace 40, the folding portion 50 may be easily formed by the folding guide line 45.

FIG. 2D illustrates a first-second folding process in which the terrace 40 is additionally folded based on the folding guide line 45. Through the first-second folding process, the folding portion 50 may have a shape folded at approximately 180 degrees. Although FIGS. 2C and 2D illustrate the first-first folding process and the first-second folding process as separate processes, the first-first folding process and the first-second folding process may be performed as a single process. The first-first folding process and the first-second folding process may form a first folding operation. After the first folding operation, a pressing process may be performed to pressurize the folding portion 50 so that the folding portion 50 maintains a folded state.

FIG. 2E illustrates a state in which an inner guide line 46 is formed in the terrace 40 of the battery cell 10. The inner guide line 46 may be formed between the electrode accommodation portion 30 and the folding guide line 45. The inner guide line 46 may be formed as a line spaced apart from the electrode accommodation portion 30 by a certain distance and formed in the length direction of the terrace 40. The inner guide line 46 may have a groove shape. The inner guide line 46 may be used for folding the terrace 40 like the folding guide line 45. A process of forming the inner guide line 46 may be performed after the first folding operation as illustrated in FIG. 2E, but the present disclosure is not limited thereto. For example, the process of forming the inner guide line 46 may be performed between a process of forming the folding guide line 45 and the first folding operation.

FIG. 2F illustrates a second folding process of additionally folding the terrace 40. By the second folding process, the folding portion 50 may have a shape folded at approximately 270 degrees. The second folding process may additionally fold the terrace 40 based on the inner guide line 46. However, the second folding process may be configured as a process of folding the terrace 40 in a state in which the inner guide line 46 is not formed. The second folding process may configure a second folding operation. After the second folding operation, a sizing operation of pressurizing the folding portion 50 toward the electrode accommodation portion 30 may be performed in order to prevent the folding portion 50 folded at 270 degrees from unfolding due to a spring back phenomenon.

The folding guide line 45 may be formed to perform the first folding operation including the first-first folding process first-second folding process described above, and the inner guide line 46 may be formed to perform the second folding operation including the second folding process. However, the folding process using the folding guide line 45 and the inner guide line 46 is not limited to the process of folding at a specific angle such as 90 degrees, 180 degrees, or 270 degrees as described above. For example, in an embodiment, the folding process using the folding guide line 45 and the inner guide line 46 may also configure a process of folding an angle of the terrace 40 by various angles, such as 45 degrees, 60 degrees, 75 degrees, 120 degrees, 135 degrees, 150 degrees, 165 degrees, 195 degrees, 210 degrees, 225 degrees, 240 degrees, 255 degrees, and 285 degrees. The number of times the folding process is performed may also be changed to one or more times. In this manner, the setting of the folding angle for the terrace 40 or the number of times the folding process is performed may be changed in various manners depending on the final specifications of the battery cell 10.

Meanwhile, although FIGS. 2A to 2F illustrate a configuration in which both the folding guide line 45 and the inner guide line 46 are formed, the present disclosure may also be applied to an embodiment in which only the folding guide line 45 is formed and the inner guide line 46 is not formed. That is, the second folding process illustrated in FIG. 2F may be performed without undergoing a process of forming the inner guide line 46 illustrated in FIG. 2E.

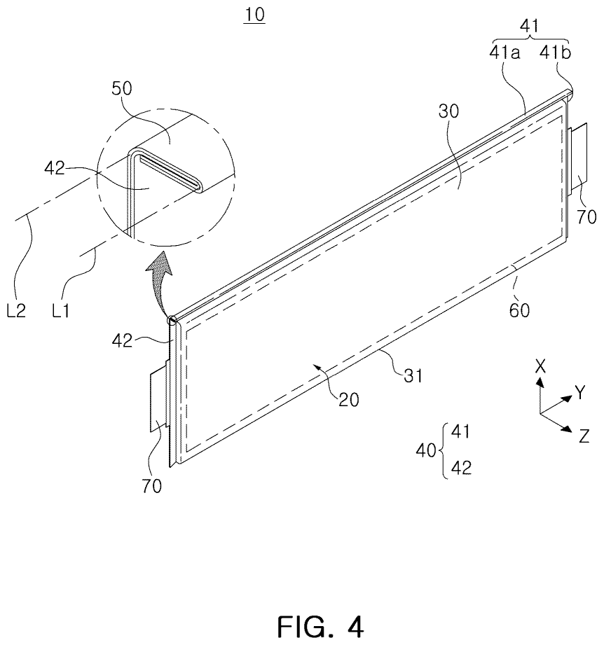

FIG. 3A is an enlarged schematic diagram illustrating part “A” of FIG. 1, and FIG. 3B is a cross-sectional view illustrating a state in which a folding guide line 45 and an inner guide line 46 are formed along line I-I′ of FIG. 3A.

Referring to FIGS. 3A and 3B, a terrace 40 may include a sealing portion 41, which is a sealed region in the terrace, and an unsealing portion 42, which is an unsealed region in the terrace. The unsealing portion 42 may be formed between the sealing portion 41 and the electrode accommodation portion 30.

An outer folding line L1 may be formed in the sealing portion 41. The outer folding line L1 is a virtual line along which the terrace 40 is first folded, and may correspond to the folding guide line 45. An inner folding line L2 may be formed in the unsealing portion 42. The inner folding line L2 is a virtual line used for the second folding that is performed after the first folding, and may correspond to the inner guide line 46.

The pouch case 20 may be formed of a plurality of layers. The pouch case 20 may have a shape in which an outer layer 21 and an inner layer 22 are stacked. The outer layer 21 may protect internal components such as the electrode assembly 60, and the inner layer 22 may include a resin layer having adhesive properties.

The outer layer 21 may include a metal layer and an insulating layer. The metal layer may secure the mechanical strength of the pouch case 20, and may prevent external air and moisture from flowing into the inside of the battery cell 10. The metal layer may be formed of aluminum. In the case of aluminum, it is advantageous to ensure a mechanical strength having a predetermined level or more and has a light weight, and to supplement electrochemical properties by the electrode assembly 60 and the electrolyte, and to improve heat dissipation. However, various materials other than aluminum may be used for the metal layer.

Since the insulating layer is formed of a material having electrical insulation and is provided on the outside of the metal layer, the insulating layer may protect the battery cell from the outside and may electrically insulate the electrode assembly 60 and the metal layer from the outside.

The inner layer 22 may be formed inwardly of the outer layer 21. For example, the inner layer 22 may be formed inwardly of the metal layer. The inner layer 22 may be composed of a material having electrical insulation and adhesiveness. For example, the inner layer 22 may include casted polypropylene (CPP) or polypropylene (PP).

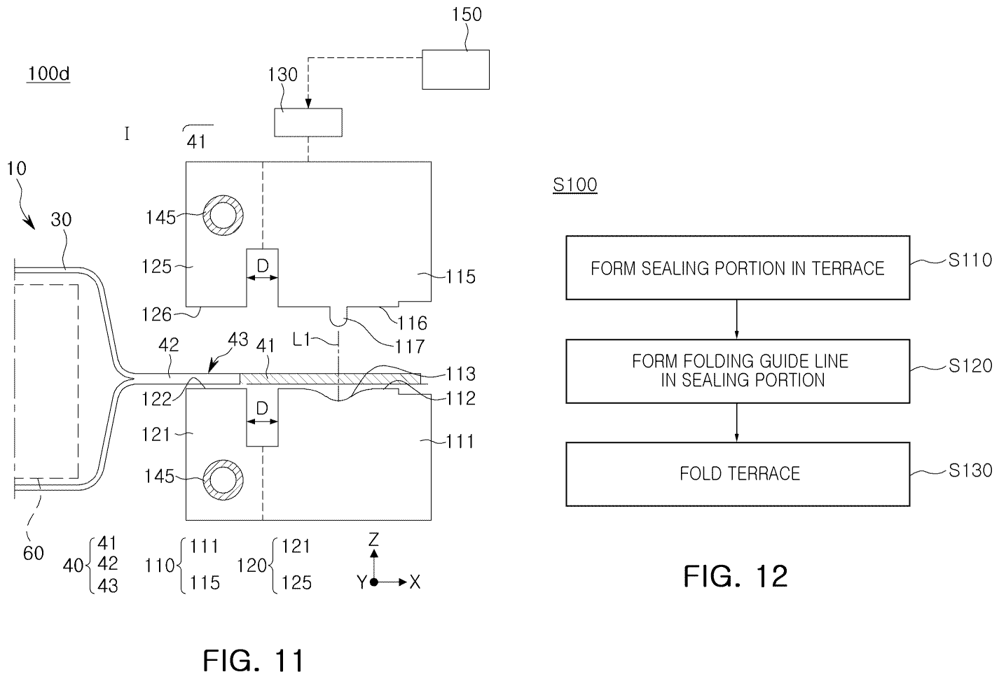

The sealing portion 41 of the terrace 40 may be formed by performing a heat-melting operation through heating and pressurizing in the sealing process (S110 of FIG. 12) in a state in which the sealing portion 41 is contact with the inner layer 22. Accordingly, after the sealing process, the sealing portion 41 may be formed by melting and curing a resin included in the inner layer 22 in the heated and pressurized portion.

Since the inner layer 22 is heated and pressurized in the sealing process, the resin included in the inner layer 22 may be pushed out of the sealing portion 41 by pressurizing force in a molten state. In this case, the molten resin may move to the unsealing portion 42.

The resin pushed out to the unsealing portion 42 is cured in an unstable form or irregularly to form an unstable region R. The unstable region R may extend from a boundary B of the sealing portion 41 and the unsealing portion 42 to the unsealing portion 42. When the first and/or second folding process is performed, cracks, or the like, may occur in the unstable region R, and thus, insulation breakdown may occur.

Additionally, the resin melted in the sealing process and then pushed out to the unsealing portion 42 may reach around the inner guide line L2, and in this case, the unstable region R may overlap or be adjacent to the inner folding line L2. When the unstable region R overlaps or is adjacent to the inner folding line L2, insulation breakdown due to cracks, or the like, may occur on or near the inner folding line L2 during the second folding process.

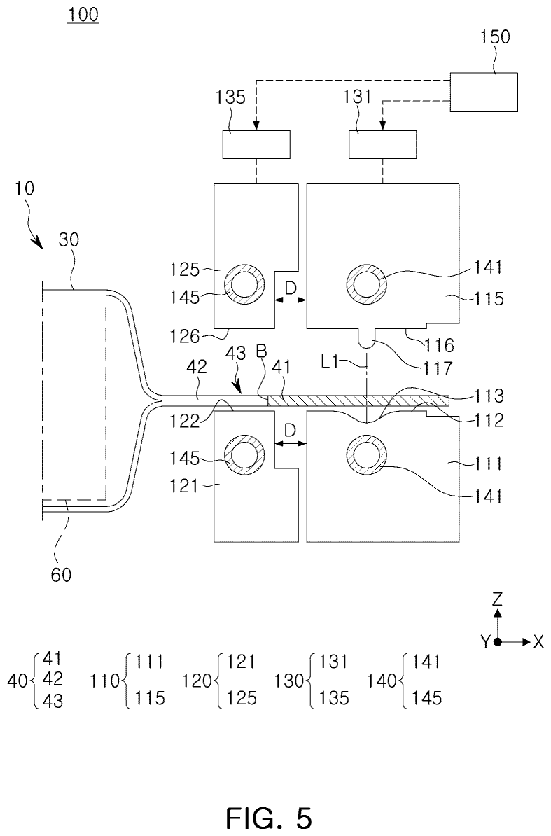

FIG. 4 is a perspective view illustrating a battery cell 10 according to an embodiment.

Referring to FIG. 4, the battery cell 10 may include a pouch case 20 and an electrode assembly 60 accommodated inside the pouch case 20. The pouch case 20 may include an electrode accommodation portion 30 in which an accommodation space 35 for accommodating the electrode assembly 60 is formed, and a terrace 40 disposed around at least a portion of the electrode accommodation portion 30. The terrace 40 may extend outwardly from the electrode accommodation portion 30.

The terrace 40 may include a sealing portion 41 and an unsealing portion 42. The sealing portion 41 may include a first sealing portion 41a in which an electrode lead 70 is not disposed and a second sealing portion 41b in which an electrode lead 70 is disposed. The first sealing portion 41a may be folded based on the outer folding line L1 and then further folded based on the inner folding line L2.

In FIG. 4, the folding portion 50 is illustrated as having a 270-degree folded shape, but the folding portion 50 may be folded at an angle greater than 270 degrees. In order to prevent the folding portion 50 from being easily unfolded due to the spring back phenomenon, the folding portion 50 may be attached to the electrode accommodation portion 30 using a tape.

FIG. 5 is a schematic diagram illustrating an apparatus 100 for forming a folding guide line according to an embodiment, and illustrates a state before pressurizing the terrace 40. The battery cell 10 of FIG. 5 illustrates a state in which the terrace 40 is sealed and the sealing portion 41 and the unsealing portion 42 are formed on the terrace 40.

Referring to FIG. 5, the apparatus 100 for forming a folding guide line according to an embodiment may include a forming tool 110 and a heating press 120.

The forming tool 110 may form a folding guide line 45 on the terrace 40 disposed at least in a portion of the periphery of the electrode accommodation portion 30 of the battery cell 10.

The forming tool 110 may pressurize the terrace 40 with the terrace 40 interpose therebetween to form a folding guide line 45 on the terrace 40. The forming tool 110 may form a folding guide line 45 on the sealing portion 41 of the terrace 40. The folding guide line 45 may be formed in a position corresponding to an outer folding line L1.

The forming tool 110 may include a first pressurizing tool 111 and a second pressurizing tool 115 disposed vertically with the terrace 40 interposed therebetween. The first pressurizing tool 111 may include a flat first pressurizing surface 112 and an accommodation groove 113 having a recessed form in the first pressurizing surface 112. The second pressurizing tool 115 may include a flat second pressurizing surface 116 and a pressurizing projection 117 disposed in a position corresponding to the accommodation groove 113 and having a shape in which at least a portion thereof protrudes from the second pressurizing surface 116. The sealing portion 41 of the terrace 40 may be pressurized by the pressurizing projection 117 and deformed toward the accommodation groove 113, and accordingly, a folding guide line 45 may be formed in the sealing portion 41. The pressurizing projection 117 may be arranged to face the accommodation groove 113 based on a second direction (Z-direction). The pressurizing projection 117 may be formed as a protrusion portion having a curved shape. The pressurizing projection 117 may pressurize the sealing portion 41 toward the accommodation groove 113 when forming the folding guide line 45. The pressurizing projection 117 may have a narrower width than a width of the accommodation groove 113 based on a first direction (X-direction) in which the terrace 40 extends.

The heating press 120 may heat an inner region 43 of the terrace 40. The inner region 43 of the terrace 40 may be defined as a region heated by the heating press 120. The inner region 43 may be disposed between the folding guide line 45 and the electrode accommodation portion 30. The inner region 43 heated by the heating press 120 may include at least a portion of the unsealing portion 42.

The inner region 43 may include at least a portion of the unstable region R described in FIG. 3A. The inner region 43 may include a region in which a molten resin is pushed out of the sealing portion 41 during the sealing process and is cured in an unstable form or is irregularly cured. The unstable region R may correspond to a region extending from a boundary B between the sealing portion 41 and the unsealing portion 42 to the unsealing portion 42. The inner region 43 may include a region in which insulation breakdown may occur due to cracks, or the like, during the conventional folding process.

The heating press 120 may be disposed between the forming tool 110 and the electrode accommodation portion 30 in the first direction (X-direction) in which the terrace 40 extends from the electrode accommodation portion 30. Accordingly, the inner region 43 heated by the heating press 120 may be a region between the forming tool 110 and the electrode accommodation portion 30. The heating press 120 may heat a region including at least a portion of the unsealing portion 42 of the terrace 40.

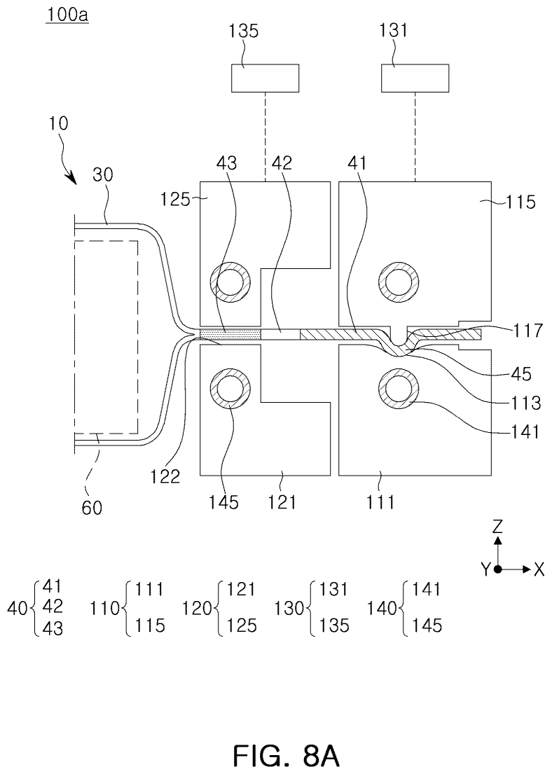

The inner region 43 may include the boundary B between the sealing portion 41 and the unsealing portion 42, and in this case, the heating press 120 may heat a portion of the sealing portion 41 and a portion of the unsealing portion 42 at the same time. In contrast, as illustrated in FIG. 7, when the inner region 43 is spaced from the sealing portion 41 and is disposed adjacently to the electrode accommodation portion 30, the heating press 120 may heat the unsealing portion 42 spaced from the sealing portion 41.

The heating press 120 may heat the inner region 43 at a preset temperature to stabilize the unstable region R, thereby eliminating cracks and other insulation breakdown factors. The heating press 120 may simultaneously heat a portion of the sealing portion 41 and a portion of the unsealing portion 42. The heating press 120 may heat the unstable region R of the terrace 40 to melt the resin layer and make the resin layer uniform. Accordingly, the insulation performance of the terrace 40 may be improved or restored, and the insulation performance of the battery cell 10 may be improved as compared to the previous process. In addition, as shown in FIG. 7, the heating press 120 may heat the inner folding line L2 to form a new sealed region around the inner folding line L2, thereby improving the insulation performance of the terrace 40 and preventing insulation breakdown from occurring in the terrace 40 during the second folding process.

A set temperature of the heating press 120 may be set to a value for stabilizing the unstable region R and/or forming the new sealed region. The set temperature of the heating press 120 may be higher than the melting temperature of the resin layer provided in the terrace 40. For example, the set temperature of the heating press 120 may be equal to or higher than 150 degrees Celsius. In addition, the set temperature of the heating press 120 may have a value of 200 degrees Celsius or lower or 180 degrees Celsius or lower so that the heating temperature is not excessively high.

The heating press 120 may include a first press 121 and a second press 125 disposed vertically with the terrace 40 interposed therebetween. The first press 121 may include a flat first heating surface 122, and the second press 125 may include a flat second heating surface 126.

In the first direction (X-direction) in which the terrace 40 extends from the electrode accommodation portion 30, the pressurizing surface (e.g., the first pressurizing surface and/or the second pressurizing surface) of the forming tool 110 and the heating surface (e.g., the first heating surface and/or the second heating surface) of the heating press 120 may be spaced apart from each other. When a pressurizing region of the inner region 43 heated by the heating press 120 and a pressurizing region of the sealing portion 41 heated by the forming tool 110 may be spaced apart from each other, the pressurizing regions of the inner region 43 and the sealing portion 41 may have little influence on each other by heating temperature. Accordingly, the influence of the heating temperature of the inner region 43 on the heating temperature of the pressurizing region of the sealing portion 41 may be reduced. Meanwhile, it may also be possible to independently control the heating temperature of the inner region 43 of the terrace 40 and the heating temperature of the pressurizing region of the sealing portion 41.

The first heating surface 122 may be disposed to be spaced apart from the first pressurizing surface 112, and the second heating surface 126 may be spaced apart from the second pressurizing surface 116. For example, the first heating surface 122 and the first pressurizing surface 112 may be spaced apart by a preset distance D, and the second heating surface 126 and the second pressurizing surface 116 may be spaced apart by the preset distance D.

When forming the folding guide line 45, the forming tool 110 and the heating press 120 may operate simultaneously. Accordingly, the formation of the folding guide line 45 and the stabilization of the inner region 43 may be performed simultaneously.

When forming the folding guide line 45, the forming tool 110 and the heating press 120 may be driven independently. For example, the forming tool 110 and the heating press 120 may have different values for at least one of heating temperature, pressurizing force, pressurizing time, and pressurizing height. A pressurizing height may correspond to a gap between the forming tool 110 and the terrace 40 or a gap between the heating press 120 and the terrace 40 when heating or pressurizing the terrace 40.

An apparatus 100 for forming a folding guide line according to an embodiment may additionally include a driver 130. The forming tool 110 and the heating press 120 may be driven together by one driver 130, but may also be driven independently of each other.

The driver 130 may include a first driver 131 driving the forming tool 110 to pressurize the terrace 40, and a second driver 135 driving the heating press 120 to pressurize the heating press 120. The first driver 131 and the second driver 135 may operate the forming tool 110 and the heating press 120 simultaneously or sequentially in the process of forming the folding guide line 45. When the driver 130 includes the first driver 131 and the second driver 135 operating independently of each other, pressurizing force, pressurizing time, a pressurizing height, and the like, of the forming tool 110 and the heating press 120 may be independently adjusted. Specifically, the implementation of the insulation performance may be achieved by controlling at least portions of a heating temperature, a pressurizing pressure or a pressurizing time, and when the forming tool 110 and the heating press 120 operate independently, this may be advantageous for improving and recovering the insulation performance.

When the first driver 131 forms the folding guide line 45 by the forming tool 110, the first driver 131 may drive at least one of the first pressurizing tool 111 and the second pressurizing tool 115 so that the first pressurizing tool 111 and the second pressurizing tool 115 move relative to each other in the second direction (Z-direction). For example, when the first pressurizing tool 111 has a fixed position, the first driver 131 may raise or lower the second pressurizing tool 115. However, the first driver 131 may be configured to drive the second press tool 115, or may be configured to drive both the first pressurizing tool 111 and the second pressurizing tool 115.

The second driver 135 may drive at least one of the first press 121 and the second press 125 so that the first press 121 and the second press 125 move relative to each other in the second direction (Z-direction) when the inner region 43 is heated by the heating press 120. For example, when the first press 121 has a fixed position, the second driver 135 may raise or lower the second press 125. However, the second driver 135 may be configured to drive the second press 125, or may be configured to drive both the first press 121 and the second press 125.

The apparatus 100 for forming a folding guide line according to an embodiment may additionally include a heating portion 140. The heating portion 140 may heat at least one of the forming tool 110 and the heating press 120. The forming tool 110 and the heating press 120 may be heated together by a single heating portion 140, but may also be heated independently of each other.

The heating portion 140 may include a first heater 141 heating the forming tool 110 and a second heater 145 heating the heating press 120.

The first heater 141 may be installed in at least one of the first press tool 111 and the second press tool 115, and the second heater 145 may be installed in at least one of the first press 121 and the second press 125. When the heating portion 140 includes both the first heater 141 and the second heater 145, the set temperature of the first heater 141 and the set temperature of the second heater 145 may have different values.

When forming the folding guide line 45, the forming tool 110 may operate at a first set temperature and the heating press 120 may operate at a second set temperature.

A second set temperature of the heating press 120 may have a higher value than the first set temperature of the forming tool 110. For example, the first set temperature of the forming tool 110 may have a range of 100 to 110 degrees Celsius, and the second set temperature of the heating press 120 may have a range of 150 degrees Celsius or higher.

When the forming tool 110 is heated, deformation of the sealing portion 41 becomes easy when forming the folding guide line 45, and accordingly, the folding guide line 45 may be easily formed. However, when a heating temperature of the forming tool 110 is significantly high, the resin layer provided in the terrace 40 may be excessively melted and flow, in which case the insulation performance may deteriorate. Accordingly, the first set temperature of the forming tool 110 may be set below the melting temperature of the resin layer. The melting temperature of the resin layer may vary depending on the type or properties of the resin layer forming the pouch case. However, the present disclosure does not exclude a component in which the folding guide line 45 is formed at room temperature without heating the forming tool 110.

The heating press 120 may heat a region including at least a portion of the unsealing portion 42 of the terrace 40 to stabilize the unstable area R or form a new sealed region. To this end, the second set temperature of the heating press 120 may be equal to or higher than the melting temperature of the resin layer provided in the terrace 40. For example, the second set temperature of the heating press 120 may have a value of 150 degrees Celsius or higher and 200 degrees Celsius or lower. The second set temperature of the heating press 120 may vary depending on the type or properties of the resin layer forming the pouch case.

A controller 150 may control the driving of the driver 130 and the heating of the heating portion 140. The heating temperature of the heating portion 140 and the pressurizing force and pressurizing time by the driver 130 may be set to a value suitable for forming the folding guide line 45 in consideration of a melting temperature of the resin layer included in the pouch case 20, a thickness of the pouch case, or the like. At least one of the heating temperature, the pressurizing force, the pressurizing time or the pressurizing height of the forming tool 110 and the heating press 120 may be controlled by the control of the controller 150.

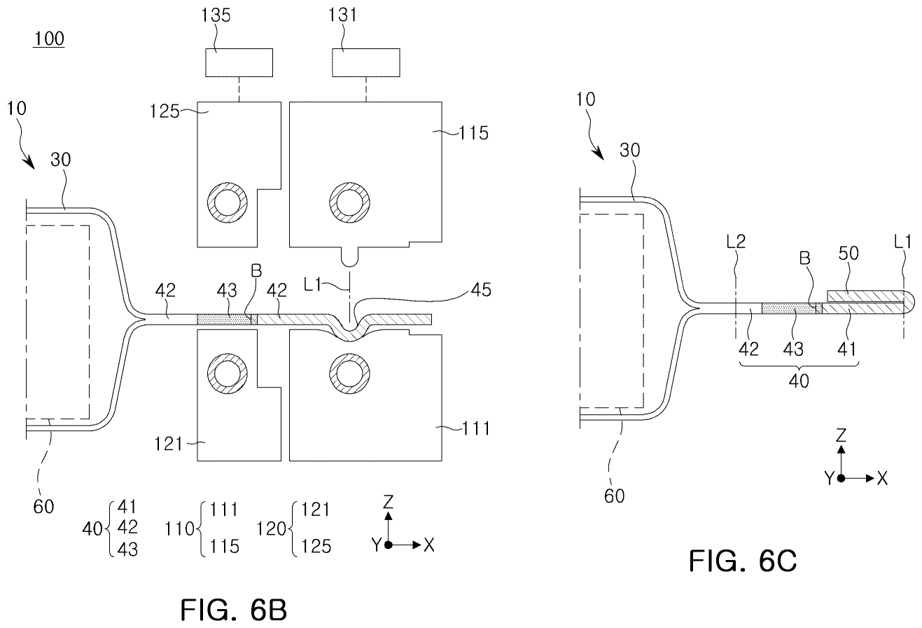

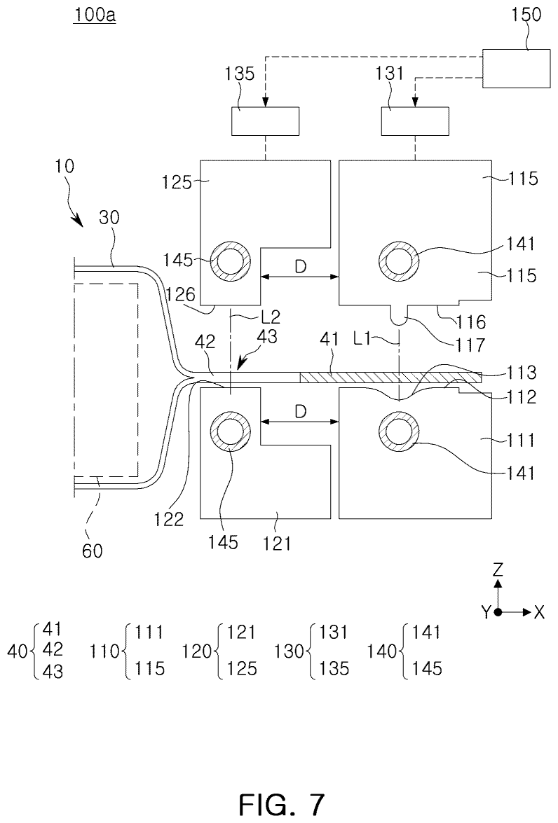

FIGS. 6A and 6B illustrate an apparatus 100 for forming a folding guide line according to an embodiment. FIG. 6A illustrates a state in which a terrace 40 is pressurized, FIG. 6B illustrates a state in which a folding guide line 45 is formed in a sealing portion 41 by pressurizing the terrace 40. FIG. 6C illustrates a state in which the terrace 40 is first folded based on the folding guide line 45 formed in FIG. 6B.

Referring to FIGS. 6A to 6C, the forming tool 110 may form a folding guide line 45 in the sealing portion 41 by pressurizing the sealing portion 41 of the terrace 40 between a pressurizing protrusion 117 of a second pressurizing tool 115 and an accommodation groove 113 of a first pressurizing tool 111.

The heating press 120 may heat the inner region 43 of the terrace 40 between the first heating surface 122 of the first press 121 and the second heating surface 126 of the second press 125 to stabilize the inner region 43. The inner region 43 may include a boundary B of the sealing portion 41 and the unsealing portion 42. In this case, the heating press 120 may heat a portion of the sealing portion 41 and a portion of the unsealing portion 42 at the same time. The heating press 120 may heat the unstable region R (see FIG. 3A) of the terrace 40 to melt the resin layer and make the resin layer uniform. The heating press 120 may heat the inner region 43 including the unstable region R to cure the resin layer of the inner region 43 in a stable state. Accordingly, the insulation performance of the terrace 40 may be improved or restored, and may improve the insulation performance of the battery cell 10 as compared to the previous process.

The terrace 40 on which the folding guide line 45 is formed may be folded based on the folding guide line 45. As shown in FIG. 6C, a folding portion may have a state folded at 180 degrees based on the outer folding line L1. The inner region 43 heated and stabilized by the heating press 120 may include the boundary B of the sealing portion 41 and the unsealing portion 42 and may span the sealing portion 41 and the unsealing portion 42. In FIG. 6C, the inner region 43 is illustrated as not including the inner folding line L2, but it may also be possible for the inner region 43 to include both the boundary B of the sealing portion 41 and the unsealing portion 42 and the inner folding line L2.

FIG. 7 is a schematic diagram illustrating an apparatus 100 for forming a folding guide line according to another embodiment, and illustrates a state before pressurizing the terrace 40.

A forming apparatus 100a for a folding guide line illustrated in FIG. 7 has a difference from the apparatus 100 for forming a folding guide line illustrated in FIG. 5 in a position of the inner region 43 heated by the heating press 120.

The inner region 43 heated by the heating press 120 may be spaced apart from the sealing portion 41. In this case, the heating press 120 may heat the unsealing portion 42 spaced apart from the sealing portion 41. The inner region 43 may include a region in which an inner folding line L2 provided to fold the terrace 40 in a different position from the folding guide line 45 is disposed. That is, the first heating surface 122 of the first press 121 and the second heating surface 126 of the second press 125 may heat the inner region 43 including the inner folding line L2.

The heating press 120 may heat the inner folding line L2 to form a new sealed region around the inner folding line L2, thereby improving the insulation performance of the terrace 40 and preventing insulation breakdown in the terrace 40 during a second folding process.

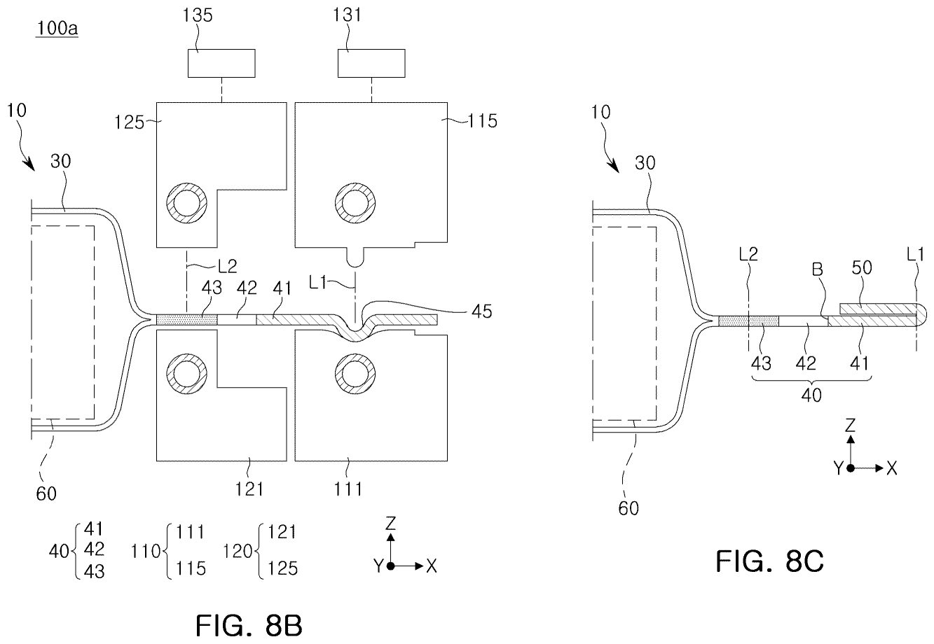

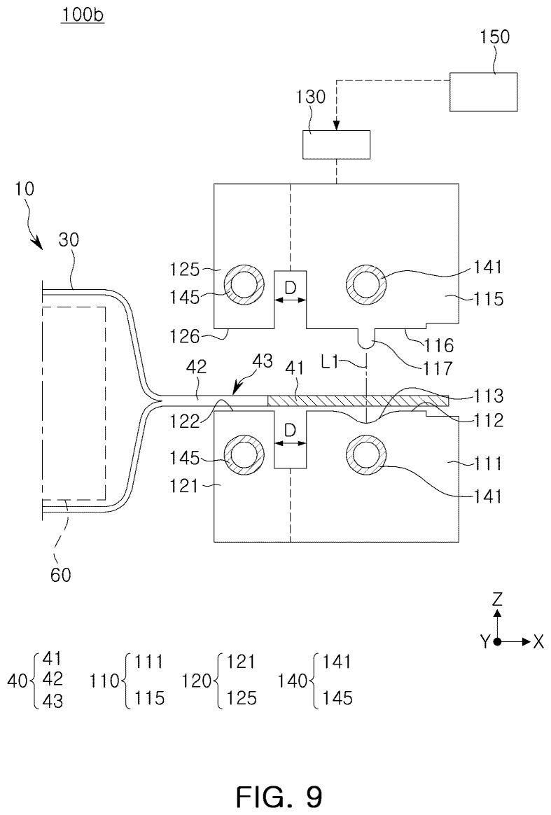

FIGS. 8A and 8B illustrate an apparatus 100 for forming a folding guide line according to another embodiment, and FIG. 8A illustrates a state in which a terrace 40 is pressurized, and FIG. 8B illustrates a state in which a folding guide line 45 is formed by pressurizing the terrace 40. FIG. 8C illustrates a state in which the terrace 40 is first folded based on the folding guide line 45 formed in FIG. 8B.

Referring to FIGS. 8A to 8C, the forming tool 110 may form the folding guide line 45 in the sealing portion 41 by pressurizing the sealing portion 41 of the terrace 40 between the pressurizing protrusion 117 of the second pressurizing tool 115 and the accommodation groove 113 of the first pressurizing tool 111.

The heating press 120 may heat the inner region 43 of the terrace 40 between the first heating surface 122 of the first press 121 and the second heating surface 126 of the second press 125 to stabilize the inner region 43. The inner region 43 heated by the heating press 120 may be spaced apart from the sealing portion 41, and may include a region in which the inner folding line L2 is disposed. The heating press 120 may heat the inner region 43 including the inner folding line L2 to melt the resin layer and make the resin layer uniform. The heating press 120 may heat the inner folding line L2 to form a new sealed region around the inner folding line L2, thereby improving the insulation performance of the terrace 40, as well as preventing insulation breakdown from occurring in the terrace 40 during the second folding process.

The terrace 40 in which the folding guide line 45 is formed may be folded based on the folding guide line 45. As shown in FIG. 8C, the folding portion may have a state folded at 180 degrees based on the outer folding line L1. The inner region 43 heated and stabilized by the heating press 120 may include the inner folding line L2. Accordingly, even when the second folding is performed based on the inner folding line L2, problems such as cracks and insulation breakdown may be improved.

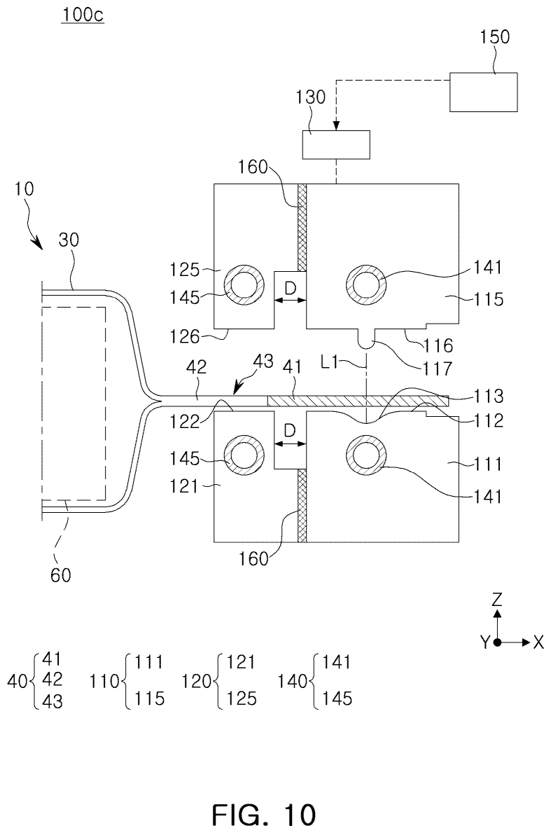

FIGS. 9 to 11 are schematic diagrams illustrating an apparatus 100 for forming a folding guide line according to another embodiment.

As compared to the apparatus 100 for forming a folding guide line illustrated in FIG. 5, a forming apparatus 100b for a folding guide line illustrated in FIG. 9 is different in that the forming tool 110 and the heating press 120 are operated by a single driver 130. In this case, the forming tool 110 and the heating press 120 may be physically connected and may be simultaneously operated by the driver 130.

As compared to the apparatus 100 for forming a folding guide line illustrated in FIG. 5, a forming apparatus 100c for a folding guide line illustrated in FIG. 10 is different in that the forming tool 110 and the heating press 120 are operated by a single driver 130, and an insulating member 160 is disposed between the forming tool 110 and the heating press 120. The forming tool 110 and the heating press 120 may be physically connected and may be driven simultaneously by the driver 130. In addition, the insulating member 160 may be disposed between the forming tool 110 and the heating press 120 to limit heat transfer between the forming tool 110 and the heating press 120. Accordingly, when the insulating member 160 is disposed, temperatures of a pressurizing surface of the forming tool 110 and a pressurizing surface of the heating press 120 may be controlled more stably.

As compared to the apparatus 100 for forming a folding guide line illustrated in FIG. 5, a forming apparatus 100d for a folding guide line illustrated in FIG. 11 is different in that the forming tool 110 and the heating press 120 are operated by a single driver 130, and the second heater 145 is disposed only on the heating press 120 while a heating portion is not disposed on the forming tool 110.

The forming tool 110 and the heating press 120 may be physically connected and may be simultaneously operated by the driver 130. In addition, even when the heating portion is not disposed on the forming tool 110, the forming tool 110 may be heated to a certain degree by the second heater 145 of the heating press 120.

FIG. 12 is a flow chart illustrating a method (S100) for manufacturing a battery cell according to an embodiment. Hereinafter, referring to FIG. 12 together with FIGS. 1 to 11, a method for manufacturing a battery cell (S100) will be described.

A method for manufacturing a battery cell (S100) according to an embodiment of the present disclosure may include a sealing process (S110) and a folding guide line forming process (S120).

The sealing process (S110) is a process of forming a sealing portion 41 by sealing a terrace 40 disposed in at least portion of a periphery of an electrode accommodation portion of a battery cell. The sealing process (S110) may seal the terrace 40 in a state in which an electrode assembly 60 is disposed inside a pouch case 20. A battery cell 10 undergoing the sealing process (S110) may have a shape as shown in FIG. 1. According to the sealing process (S110), the terrace 40 of the battery cell may include a sealing portion 41 which is a region sealed by the sealing process (S110) and an unsealing portion 42 which is a region not sealed by the sealing process (S110).

The folding guide line forming process (S120) is a process of forming a folding guide line 45 in the sealing portion 41 of the terrace 40.

The folding guide line forming process (S120) may heat the inner region 43 of the terrace 40 while forming the folding guide line 45 in the terrace 40. For example, the folding guide line 45 may be formed by the forming tool 110 illustrated in any one of FIGS. 5 to 11, and the heating of the inner region 43 may be performed by a heating press 120 illustrated in any one of FIGS. 5 to 11. The inner region 43 may be disposed between the folding guide line 45 and the electrode accommodation portion 30.

A pressurizing surface on which the folding guide line 45 is formed and a heating surface provided as the inner region 43 may be spaced apart from each other. The pressurizing surface and the heating surface may be spaced apart from each other in the first direction (X-direction) in which the terrace 40 extends from the electrode accommodation portion 30. For example, the pressurizing surface may be formed in the forming tool 110 and the heating surface may be formed in the heating press 120. In this case, the pressurizing surface (e.g., the first pressurizing surface and/or second pressurizing surface) of the forming tool 110 and the heating surface (e.g., the first heating surface and/or second heating surface) of the heating press 120 may be spaced apart from each other in the first direction.

The folding guide line forming process (S120) may eliminate cracks and other insulation breakdown factors by heating the inner region 43 of the terrace 40 by a preset temperature to stabilize the unstable region R. The inner region 43 heated by the folding guide line forming process (S120) may include at least a portion of the unsealing portion 42 as shown in FIGS. 5 to 11.

In an embodiment, the heating surface provided to the inner region 43 may include the boundary B (see FIG. 6B) between the sealing portion 41 and the unsealing portion 42 as shown in FIGS. 6A to 6C and FIGS. 9 to 11. In this case, the heating surface provided to the inner region 43 may simultaneously heat a portion of the sealing portion 41 and a portion of the unsealing portion 42. For example, the heating press 120 may heat a region including the boundary B of the sealing portion 41 and the unsealing portion 42 to form the inner region 43. In this case, the folding guide line forming process (S120) may heat an unstable region R of the terrace 40 to melt a resin layer and make the resin layer uniform. Accordingly, the insulation performance of the terrace 40 may be improved or restored, and the insulation performance of the battery cell 10 may be improved compared to the previous process.

In another embodiment, the heating surface provided to the inner region 43 may be spaced apart from the sealing portion 41, as shown in FIGS. 8A to 8C. The heating surface provided to the inner region 43 may heat the unsealing portion 42 in a position spaced apart from the boundary B (see FIG. 8C) between the sealing portion 41 and the unsealing portion 42. The inner region 43 may include a region in which an inner folding line (L2 in FIG. 8b) provided to fold the terrace 40 in a different position from the folding guide line 45 is disposed. For example, the heating press 120 may heat the inner region 43 including the inner folding line L2. In this case, by forming a new sealed region around the inner folding line L2, the insulation performance of the terrace 40 may be improved, and insulation breakdown may be prevented from occurring in the terrace 40 during the second folding process.

The method for manufacturing a battery cell (S100) according to an embodiment of the present disclosure may additionally include a folding process (S130) of folding the terrace 40 after the folding guide line forming process (S120).

The folding process (S130) may fold the first sealing portion 41a, among the sealing portions 41 of the terrace 40 in which the electrode lead 70 is not disposed. In an embodiment, the terrace 40 may form a folding portion 50 folded at a specific angle after undergoing at least one folding process (S130).

The folding process (S130) may include a process of folding the terrace 40 based on the folding guide line 45 as shown in FIG. 2C. Since the folding guide line 45 having a groove shape is formed in advance on the terrace 40, the folding portion 50 may be easily formed by the folding guide line 45.

The folding process (S130) may include a process of additionally folding the terrace 40 based on the folding guide line 45 as shown in FIG. 2D. In FIG. 2D, the folding portion 50 may have a shape folded at approximately 180 degrees. In FIG. 2D, the terrace 40 may also be folded based on the folding guide line 45. In FIGS. 2C and 2D, a process of folding the terrace 40 to 180 degrees based on the folding guide line 45 is illustrated as two separate process, but the process in FIGS. 2C and 2D may also be performed as a single process.

The folding process (S130) may include a process of additionally folding the terrace 40, as illustrated in FIG. 2F. In FIG. 2F, the folding portion 50 may have a shape folded at approximately 270 degrees. After terminating the folding process (S130), the battery cell 10 may have, for example, a shape of FIG. 4.

The above-described contents are merely examples of applying the principles of the present disclosure, and other components may be further included without departing from the scope of the present disclosure. In addition, some of the components in the above-described embodiments may be deleted and implemented, and each embodiment may be implemented in combination with each other.

For example, the present disclosure may include a form in which some of the components in the embodiments of the forming apparatuses 100, 100a, 100b, 100c and 100d for a folding guide line illustrated in FIGS. 5 to 11 are combined with each other.

What is claimed is:

1. An apparatus for forming a folding guide line, comprising:
a forming tool forming a folding guide line in a terrace disposed in at least a portion of a periphery of an electrode accommodation portion of a battery cell; and
a heating press heating an inner region of the terrace,
wherein the inner region of the terrace heated by the heating press is disposed between the folding guide line and the electrode accommodation portion.

2. The apparatus for forming a folding guide line of claim 1, wherein the heating press is disposed between the forming tool and the electrode accommodation portion in a first direction in which the terrace extends from the electrode accommodation portion.

3. The apparatus for forming a folding guide line of claim 2, wherein a pressurizing surface of the forming tool and a heating surface of the heating press are spaced apart from each other in the first direction.

4. The apparatus for forming a folding guide line of claim 1, wherein the terrace includes a sealing portion, which is a sealed region, and an unsealing portion, which is an unsealed region,
the forming tool forms the folding guide line in the sealing portion, and
the heating press heats a region including at least a portion of the unsealing portion.

5. The apparatus for forming a folding guide line of claim 4, wherein the inner region of the terrace includes a boundary between the sealing portion and the unsealing portion, and
the heating press simultaneously heats a portion of the sealing portion and a portion of the unsealing portion.

6. The apparatus for forming a folding guide line of claim 4, wherein the inner region of the terrace is spaced apart from the sealing portion, and
the heating press heats the unsealing portion.

7. The apparatus for forming a folding guide line of claim 6, wherein the inner region of the terrace includes a region in which an inner folding line provided to fold the terrace in a different position from the folding guide line is disposed.

8. The apparatus for forming a folding guide line of claim 1, wherein the forming tool and the heating press are independently driven.

9. The apparatus for forming a folding guide line of claim 8, wherein the forming tool and the heating press have different values for at least one of a heating temperature, pressurizing force, pressurizing time or a pressurizing height.

10. The apparatus for forming a folding guide line of claim 8, further comprising:
a first driver driving the forming tool to pressurize the terrace; and
a second driver driving the heating press to pressurize the heating press.

11. The apparatus for forming a folding guide line of claim 8, wherein a second set temperature of the heating press has a higher value than a first set temperature of the forming tool.

12. The apparatus for forming a folding guide line of claim 11, wherein the second set temperature is equal to or higher than a melting temperature of a resin layer provided in the terrace.

13. The apparatus for forming a folding guide line of claim 1, further comprising:
a heating portion including a first heater heating the forming tool, and a second heater heating the heating press,
wherein a set temperature of the first heater and a set temperature of the second heater have different values.

14. The apparatus for forming a folding guide line of claim 1, wherein the forming tool and the heating press are driven together by a single driver.

15. A manufacturing method of a battery cell, comprising:
a sealing process of forming a sealing portion by sealing a terrace disposed in at least a portion of a periphery of an electrode accommodation portion of a battery cell; and
a folding guide line forming process of forming a folding guide line in the sealing portion of the terrace,
wherein the folding guide line forming process heats an inner region of the terrace while forming a folding guide line in the terrace,
the inner region of the terrace is disposed between the folding guide line and the electrode accommodation portion, and
a pressurizing surface on which the folding guide line is formed and a heating surface provided to the inner region of the terrace are spaced apart from each other.

16. The manufacturing method of a battery cell of claim 15, wherein the terrace includes the sealing portion, which is a region sealed by the sealing process, and an unsealing portion, which is a region unsealed by the sealing process, and
the inner region of the terrace heated by the folding guide line forming process includes at least a portion of the unsealing portion.

17. The manufacturing method of a battery cell of claim 16, wherein the heating surface provided as the inner region of the terrace includes a boundary between the sealing portion and the unsealing portion, or is spaced apart from the sealing portion.

18. The manufacturing method of a battery cell of claim 15, further comprising:
a folding process of folding the terrace after the folding guide line forming process,
wherein the folding process includes a process of folding the terrace based on the folding guide line.

19. A battery cell, comprising:
an electrode assembly; and
a pouch case including an electrode accommodation portion forming an accommodation space for accommodating the electrode assembly, and a terrace disposed in at least a portion of a periphery of the electrode accommodation portion and extending outwardly from the electrode accommodation portion,
wherein the terrace includes a folding guide line formed by an apparatus for forming a folding guide line of claim 1.

20. The battery cell of claim 19, wherein the terrace has a folded shape based on the folding guide line.
